(19) United States
(12) Patent Application Publication
(10) Pub. No.: US 2025/0054967 A1
(43) Pub. Date: Feb. 13, 2025

(54) LITHIUM NICKEL-BASED COMPOSITE OXIDE AS A POSITIVE ELECTRODE ACTIVE MATERIAL FOR RECHARGEABLE SOLID-STATE BATTERIES

(71) Applicant: Umicore, Brussels (BE)

(72) Inventors: Shinichi KUMAKURA, Olen (BE); Veerle GOOSSENS, Olen (BE); TaeHyeon YANG, Chungcheongnam-do (KR)

(21) Appl. No.: 18/719,283

(22) PCT Filed: Dec. 16, 2022
(86) PCT No.: PCT/EP2022/086276

§ 371 Date: Jun. 13, 2024

(30) Foreign Application Priority Data
Dec. 17, 2021 (EP) 21215648.3

(51) Int. Cl. H01M 4/525; C01G 53/00; H01M 10/0562

(52) U.S. Cl. CPC H01M 4/525; C01G 53/44; H01M 10/0562; C01P 2002/54; C01P 2002/85; C01P 2006/12; C01P 2006/40; H01M 2300/0068

(57) ABSTRACT

A positive electrode active material comprises Li, M′, and oxygen. M′ comprises Ni in a content x, Mn in a content y, Co in a content z, D in a content a, Zr in a content b, wherein 55.0 mol %≤x≤95.0 mol %, 0.0 mol %≤y≤40.0 mol %, 0.0 mol %≤z≤40.0 mol %, 0.0 mol %≤a≤2.0 mol %, and 0.01 mol %≤b≤5.0 mol %. D is at least one element other than Li, Ni, Mn, Co, and O. The positive electrode active material has a Zr content Zr_{X} and a carbon content C. Zr_{X} is expressed as a molar fraction compared to the sum of molar fractions of Co, Mn, Ni, and Zr. C is expressed in wt. % by total weight of the positive electrode active material. The ratio of Zr_{X} to C is between 52−0.413·x and 42−0.413·x.

### TECHNICAL FIELD AND BACKGROUND

The present invention relates to a positive electrode active material for a solid-state rechargeable battery. More specifically, the invention relates to a positive electrode active material comprising Zr for a solid-state battery, preferably wherein the solid-state battery is a sulfide based all-solid state battery. The present invention also relates to a method for manufacturing said positive electrode active material. Further, the present invention relates to a solid-state battery comprising said positive electrode active material and the use of said positive electrode active material in a solid-state battery.

A lithium nickel-based oxide positive electrode active material comprising Zr compound applicable in a solid-state battery is already known, for example, from the document ACS Appl. Mater. Interfaces 2020, 12, 51, 57146-57154. The document discloses a positive electrode active material comprises Li, M′, and O wherein M′ is Ni_{0.6}Co_{0.2}Mn_{0.2}, mixed with Zr ethoxide in an ethanol solvent. Said treatment with Zr ethoxide generates a positive electrode active material with low efficiency when applied in a solid-state battery. Therefore, there is a need to provide a lithium nickel-based oxide positive electrode active material comprising Zr compound having an improved efficiency in a solid-state battery.

It is an object of the present invention to provide a positive electrode active material comprising Zr.

It is a further object of the present invention to provide a method for manufacturing said positive electrode active material.

It is a further object of the present to provide a solid-state battery comprising said positive electrode active material.

It is a further object of the present invention to provide a use of said positive electrode active material in a solid-state battery.

### SUMMARY OF THE INVENTION

This objective is achieved by providing a positive electrode active material for solid-state batteries, wherein the positive electrode active material comprises Li, M′, and oxygen, wherein M′ comprises:
Ni in a content x between 55.0 mol % and 95.0 mol %, relative to M′,
Mn in a content y, wherein 0.0 mol %≤y≤40.0 mol %,
Co in a content z, wherein 0.0 mol %≤z≤40.0 mol %,
D in a content a, wherein 0.0 mol %≤a≤2.0 mol %, wherein D is at least one element other than Li, Ni, Mn, Co, and O,
Zr in a content b, wherein 0.01 mol %≤b≤5.0 mol %,
wherein x, y, z, a, and b are measured by ICP-OES,
wherein x+y+z+a+b is 100.0 mol %,
wherein the positive electrode active material has a Zr content Zr_{X}, wherein Zr_{X} is determined by XPS analysis, wherein Zr_{X} is expressed as a molar fraction compared to the sum of molar fractions of Co, Mn, Ni, and Zr as measured by XPS analysis, wherein the positive electrode active material comprises carbon in a content C, wherein C is in wt. % as measured by carbon analyzer,
wherein the ratio of Zr_{X} to C is between 52−0.413·x and 42−0.413·x.

The present inventors have surprisingly found that by mixing a slurry of a lithium transition metal-based oxide compound, a Zr-source in an alcohol and water followed by filtering of the mixture the resulting positive electrode active material has lower ratio of Zr content over carbon content as compared to the positive electrode active material conventionally manufactured by preparing a mixture of a lithium transition metal-based oxide compound and Zr alkoxide in ethanol followed by evaporation of the ethanol from said mixture, as demonstrated in the appended examples.

### BRIEF DESCRIPTION OF THE FIGURES

FIG. 1. Graph shows Ni/M′ content (x) of the positive electrode active material in at % (x axis) versus Zr_{X}/C (ratio of Zr/(Ni+Mn+Co+Zr) as measured by XPS to carbon content in wt %; y axis). The patterned area shows the claimed range in this invention.

### DETAILED DESCRIPTION

In the drawings and the following detailed description, preferred embodiments are described in detail to enable practice of the invention. Although the invention is described with reference to these specific preferred embodiments, it will be understood that the invention is not limited to these preferred embodiments. In contrast, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

A positive electrode active material is defined as a material which is electrochemically active in a positive electrode. By active material, it must be understood a material capable to capture and release Li ions when subjected to a voltage change over a predetermined period of time.

### Positive Electrode Active Material

In a first aspect, the present invention concerns a positive electrode active material for solid-state batteries, wherein the positive electrode active material comprises Li, M′, and oxygen, wherein M′ comprises:
Ni in a content x, wherein 55.0 mol %≤x≤95.0 mol %,
Mn in a content y, wherein 0.0 mol %≤y≤40.0 mol %,
Co in a content z, wherein 0.0 mol %≤z≤40.0 mol %,
D in a content a, wherein 0.0 mol %≤a≤2.0 mol %, wherein D is at least one element other than Li, Ni, Mn, Co, and O,
Zr in a content b, wherein 0.01 mol %≤b≤5.0 mol %,
wherein x, y, z, a, and b are measured by ICP-OES,
wherein x+y+z+a+b is 100.0 mol %,
wherein the positive electrode active material has a Zr content Zr_{X}, wherein Zr_{X} is determined by XPS analysis, wherein Zr_{X} is expressed as a molar fraction compared to the sum of molar fractions of Co, Mn, Ni, and Zr as measured by XPS analysis,
wherein the positive electrode active material comprises carbon in a content C, wherein C is in wt. % by total weight of the positive electrode active material, as measured by carbon analyzer,
wherein the ratio of Zr_{X} to C is between 52−0.413·x and 42−0.413·x.

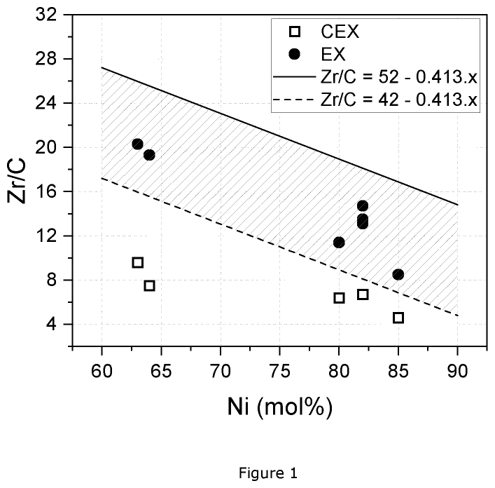

The Zr_{X} to C between 52−0.413·x and 42−0.413·x is shown in FIG. 1.

Preferably, the ratio Zr_{X} to C is between 50−0.413·x and 43−0.413·x.

As appreciated by the skilled person the unit of the ratio Zr, to C is (wt. %)¹.

In a preferred embodiment Ni is in a content x≥60.0 mol %, preferably x≥61.0 mol %, more preferably x≥62.0 mol %. In a preferred embodiment, x≤90.0 mol % preferably x≤88 mol % and more preferably x≤85.0 mol %.

A more preferred embodiment is the positive electrode active material of the invention, wherein Ni in a content x between 55.0 mol %≤x≤75.0 mol %, preferably 60.0 mol %≤x≤70.0 mol %, more preferably 62.0 mol %≤x≤68.0 mol %.

A more preferred embodiment is the positive electrode active material of the invention, wherein Ni in a content x between 75.0 mol %≤×95.0 mol %, preferably 76.0 mol %≤x≤90.0 mol %, more preferably 77.0 mol %≤x≤88.0 mol %.

As appreciated by the skilled person the amount of Li and M′, preferably Li, Ni, Mn, Co, D and Zr in the positive electrode active material is measured with Inductively Coupled Plasma-Optical Emission Spectroscopy (ICP-OES). For example, but not limiting to the invention, an Agilent ICP 720-ES is used in the ICP-OES analysis.

In a preferred embodiment Mn is in a content y>0.0 mol %, more preferably y≥5.0 mol %, and even more preferably y≥8.0 mol %. In a preferred embodiment the content is y≤40.0 mol %, preferably y≤30.0 mol %, and more preferably y≤25.0 mol %. In a preferred embodiment the content is 0.0 mol %<y≤40.0 mol %, preferably 5.0 mol %≤y≤8.0 mol %, more preferably 8.0 mol %≤y≤25.0 mol %.

In a preferred embodiment Co is in a content z>0.0 mol %, more preferably z≥1.0 mol %, and even more preferably z≥3.0 mol %. In a preferred embodiment the content is z≤40.0 mol %, more preferably z≤30.0 mol %, and even more preferably z≤25.0 mol %. In a preferred embodiment the content is 0.0 mol %<z≤40.0 mol %, preferably 1.0 mol %≤z≤30.0 mol %, more preferably 3.0 mol %≤z≤25.0 mol %.

In a preferred embodiment D is at least one element other than Li, Ni, Mn, Co, Zr and O.

In a preferred embodiment D comprises at least one element of the group consisting of: Al, B, Ba, Ca, Cr, Fe, Mg, Mo, Nb, S, Si, Sr, Ti, Y, V, W, and Zn; preferably Al, B, Cr, Nb, S, Si, Ti, Y and W.

In a highly preferred embodiment D is at least one element of the group consisting of: Al, B, Ba, Ca, Cr, Fe, Mg, Mo, Nb, S, Si, Sr, Ti, Y, V, W, and Zn; preferably Al, B, Cr, Nb, S, Si, Ti, Y and W, more preferably Al, B, Nb, Ti and W.

In a preferred embodiment D is in a content a>0.0 mol %, more preferably a≥0.25 mol %, and even more preferably a≥0.5 mol %. In a preferred embodiment the content is a≤2.0 mol %, preferably a≤1.75 mol %, and more preferably a≤1.5 mol %. In a preferred embodiment the content is 0.0 mol %<a≤2.0 mol %, preferably 0.25 mol %≤a≤1.75 mol % and more preferably 0.5 mol %≤a≤1.5 mol %.

A preferred embodiment is the positive active material of the invention, wherein Zr is in a content b>0.01 mol %, preferably b≥0.05 mol %, more preferably b≥0.10 mol %. In a preferred embodiment b≤2.5 mol %, preferably b≤2.0 mol %, more preferably b≤2 mol %. In a preferred embodiment 0.05 mol %≤b≤2.5 mol %, preferably 0.10 mol %≤b≤2.0 mol %, more preferably 0.15 mol %≤b≤2.0 mol %.

A certain preferred embodiment is the positive active material of the invention, wherein Zr is in a content b>0.01 mol %, preferably b≥0.05 mol %, more preferably b≥0.10 mol %. In a preferred embodiment b≤2.5 mol %, preferably b≤2.0 mol %, more preferably b≤1.5 mol %. In a preferred embodiment 0.05 mol %≤b≤2.5 mol %, preferably 0.10 mol %≤b≤2.0 mol %, more preferably 0.15 mol %≤b≤1.5 mol %.

In particular, Zr_{X} is the molar fraction of Zr measured in a region of a secondary particle or single-crystalline particle of the positive electrode active material according to invention defined between a first point of an external edge of said particle and a second point at a distance from said first point. Said distance separating said first to said second point being equal to a penetration depth of said XPS, said penetration depth D being comprised between 1.0 to 10.0 nm. In particular, the penetration depth is the distance along an axis perpendicular to a virtual line tangent to said external edge and passing trough said first point.

The external edge of the particle is, in the framework of this invention, the boundary or external limit distinguishing the particle from its external environment.

Therefore, XPS analysis provides atomic content of elements in an uppermost layer of a particle with a penetration depth of about 10.0 nm from an outer boundary of the particle. The outer boundary of the particle is also referred to as “surface”. In the framework of the present invention, at % signifies atomic percentage. The at % or “atomic percent” of a given element expression of a concentration means how many percent of all atoms in the concerned compound are atoms of said element. The designation at % is equivalent to mol % or “molar percent”. For example, but not limiting to the invention, XPS analysis is carried out with a Thermo K-α+ spectrometer (Thermo Scientific).

A preferred embodiment is the positive electrode active material of the invention, wherein the ratio Zr_{X}/b>100, preferably the ratio Zr_{X}/b>150, more preferably the ratio Zr_{X}/b>200. A preferred embodiment is the positive electrode active material of the invention, wherein the ratio Zr_{X}/b<1000, preferably the ratio Zr_{X}/b<500, more preferably the ratio Zr_{X}/b<350. A preferred embodiment is the positive electrode active material of the invention, wherein the ratio Zr_{X}/b is between 100<Zr_{X}/b<1000, preferably 150<Zr_{X}/b<500, more preferably 200<Zr_{X}/b<350.

As appreciated by the skilled person the defined ratio Zr_{X}/b refers to the positive electrode active material of the invention having an enriched amount of Zr in the surface layer of the positive electrode active material. The surface layer of the positive electrode active material is 1 to 10 nm of the uppermost part of the positive electrode active material. Worded differently, the positive electrode active material of the invention comprises a coating layer of Zr. In the context of the present invention the positive electrode active material may comprise a further coating layer comprising D, wherein D is at least one element of the group consisting of: Al, B, Ba, Ca, Cr, Fe, Mg, Mo, Nb, S, Si, Sr, Ti, Y, V, W, and Zn; preferably Al, B, Cr, Nb, S, Si, Ti, Y and W, wherein the coating layer of Zr may be placed on the further coating layer and/or the further coating layer may be placed on the coating layer of Zr and/or the positive electrode active layer may comprise a mixed coating layer comprising the coating layer of Zr and the further coating layer.

A preferred embodiment is the positive electrode active material of the invention, wherein C≤0.15 wt. % by total weight of the positive electrode active material, preferably C≤0.12 wt. %, more preferably C≤0.11 wt. % by total weight of the positive electrode active material. In a preferred embodiment is the positive electrode active material of the invention, wherein, C≥0.01 wt. % by total weight of the positive electrode active material, preferably C≥0.02 wt. %, more preferably C≥0.03 wt. % by total weight of the positive electrode active material. In a preferred embodiment is the positive electrode active material of the invention, wherein C is in an amount of 0.01-0.15 wt. % by total weight of the positive electrode active material, preferably in an amount of 0.02-0.12 wt. %, more preferably in an amount of 0.03-0.11 wt. %. As appreciated by the skilled person the carbon content of the positive electrode active material of the invention is measured with a carbon analyzer. For example, but not limiting to the invention, a Horiba Emia-Expert carbon/sulfur analyzer can be used to measure the carbon content C.

In a preferred embodiment the positive electrode active material has a surface area SA of more than 0.15 m²/g, preferably more than 0.25 m²/g, more preferably more than 0.45 m²/g.

In a preferred embodiment the positive electrode active material has a surface area SA of less than 1 m²/g, preferably less than 0.90 m²/g, more preferably less than 85 m²/g. In a preferred embodiment the positive electrode active material has a surface area SA in an amount of 0.15-1 m²/g, preferably in an amount of 0.25-0.90 m²/g, more preferably in an amount of 0.45-0.85 m²/g. As appreciated by the skilled person the surface area SA is determined by BET measurement. For example, but not limiting to the invention, the surface area can be determined with a Micromeritics Tristar II 3020.

In a preferred embodiment the positive electrode active material of the invention has a secondary particle median size D50 of at least 1.0 μm, preferably at least 2.0 μm, and more preferably of at least 3.0 μm. In a preferred embodiment the positive electrode active material of the invention has a secondary particle median size D50 of at most 20.0 μm, preferably at most 15.0 μm, and more preferably of at most 10.0 μm. In a preferred embodiment the positive electrode active material of the invention has a secondary particle median size D50 in amount of 1.0-20.0 μm, preferably in an amount of 2.0-15.0 μm, more preferably in an amount of 3.0-10.0 μm. As appreciated by the skilled person the secondary particle median size D50 is determined by laser diffraction particle size analysis. For example, but not limiting to the invention, the secondary particle median size D50 can be determined with a Malvern Mastersizer 3000.

In a preferred embodiment the positive electrode active material is a single-crystal powder. Alternatively, and in an even preferred embodiment, the positive electrode active material is a poly-crystalline powder.

The concept of single-crystalline powders is well known in the technical field of positive electrode active material. It concerns powders having mostly single-crystalline particles. Such powder are a separate class of powders compared to poly-crystalline powders, which are made of particles which are mostly poly-crystalline. The skilled person can easily distinguish such these two classes of powders based on a microscopic image.

Single-crystal particles are also known in the technical field as monolithic particles, one-body particles or and mono-crystalline particles.

Even though a technical definition of a single-crystalline powder is superfluous, as the skilled person can easily recognize such a powder with the help of an SEM, in the context of the present invention, single-crystalline powders may be considered to be defined as powders in which 80% or more of the number of particles are single-crystalline particles. This may be determined on an SEM image having a field of view of at least 45 μm×at least 60 μm (i.e. of at least 2700 μm²), and preferably of: at least 100 μm×100 μm (i.e. of at least 10,000 μm²).

Single-crystalline particles are particles which are individual crystals or which are formed of a less than five, and preferably at most three, primary particles which are themselves individual crystals. This can be observed in proper microscope techniques like Scanning Electron Microscope (SEM) by observing grain boundaries. Therefore, and as appreciated by the skilled person, the determination of secondary particle median size D50 is also applicable to the single-crystalline powder.

For the determination whether particles are single-crystalline particles, grains which have a largest linear dimension, as observed by SEM, which is smaller than 20% of the median particle size D50 of the powder, as determined by laser diffraction, are ignored. This avoids that particles which are in essence single-crystalline, but which may have deposited on them several very small other grains, for instance a poly-crystalline coating, are inadvertently considered as not being single-crystalline particles.

As appreciated by the skilled person the poly-crystalline powder consist of secondary particles comprising a plurality of primary particles, preferably more than 20 primary particles, preferably more than 10 primary particles, most preferably, more than 5 primary particles.

As appreciated by the skilled person the secondary particles constituting the poly-crystalline powder as defined herein are poly-crystalline particles. All embodiments related to the secondary particles equally apply to the polycrystalline particles as defined in the present invention

In a highly preferred embodiment the positive electrode active material of the invention material is a single-crystal powder having a ratio of C to SA of more than 0.01, preferably more than 0.03, more preferably more than 0.06. In a highly preferred embodiment the positive electrode active material of the invention material is a single-crystal powder having a ratio of C to SA of less than 0.20, preferably less than 0.15, more preferably less than 0.12. In a highly preferred embodiment the positive electrode active material of the invention material is a single-crystal powder having a ratio of C to SA in an amount of 0.01-0.20, preferably in an amount of 0.03-0.15, more preferably in an amount of 0.06-0.12.

In certain highly preferred the positive electrode active material of the invention material is a single-crystal powder having a primary particle median D50 value of less than 10.0 μm, preferably less than 8.0 μm, more preferably less than 7.0 μm. In certain preferred embodiments the positive electrode active material of the invention is a single-crystal powder having a primary particle median D50 value of more than 1.0 μm, preferably more than 2.0 μm, more preferably more than 3.0 μm. In certain preferred embodiments the positive electrode active material of the invention is a single-crystal powder having a primary particle median D50 value between 1.0 and 10.0 μm, preferably between 2.0 and 8.0 μm, more preferably between 3.0 and 5.0 μm. As appreciated by the skilled person the particle size distribution (PSD) D50 of the positive electrode active material powder is measured by laser diffraction particle size analysis. For example, but not limiting to the invention, the particle median D50 can be measured using a Malvern Mastersizer 3000.

In a highly preferred embodiment the positive electrode active material of the invention material is a poly-crystalline powder having a ratio of C to SA of more than 0.10, preferably more than 0.12, more preferably more than 0.15. In a highly preferred embodiment the positive electrode active material of the invention material is a poly-crystalline powder having a ratio of C to SA of less than 0.25, preferably less than 0.22, more preferably less than 0.20. In a highly preferred embodiment the positive electrode active material of the invention material is a poly-crystalline powder having a ratio of C to SA in an amount of 0.10-0.25, preferably in an amount of 0.12-0.22, more preferably in an amount of 0.15-0.20.

In certain highly preferred the positive electrode active material of the invention material is a poly-crystalline powder has a secondary particle median size D50 of at least 1.0 μm, preferably at least 2.0 μm, and more preferably of at least 3.0 μm. In certain highly preferred embodiments the positive electrode active material of the invention is a poly-crystalline powder and has a secondary particle median size D50 of at most 20.0 μm, preferably at most 15.0 μm, and more preferably of at most 10.0 μm. In a preferred embodiment the positive electrode active material of the invention is a poly-crystalline powder and has a secondary particle median size D50 in amount of 1.0-20.0 μm, preferably in an amount of 2.0-15.0 μm, more preferably in an amount of 3.0-10.0 μm. As appreciated by the skilled person the secondary particle median size D50 is determined by laser diffraction particle size analysis. For example, but not limiting to the invention, the secondary particle median size D50 can be determined with a Malvern Mastersizer 3000.

As appreciated by the skilled person the unit of the ratio of C to SA is wt. % (g/m²).

In a second aspect, the present invention concerns a positive electrode active material for solid-state batteries, wherein the positive electrode active material comprises Li, M′, and oxygen, wherein M′ comprises:
Ni in a content x between 55.0 mol %≤x≤75.0 mol %, preferably 60.0 mol %≤x≤70.0 mol %, more preferably 62.0 mol %≤x≤68.0 mol %;
Mn in a content y, wherein 0.0 mol %≤y≤40.0 mol %;
Co in a content z, wherein 0.0 mol %≤z≤40.0 mol %;
D in a content a, wherein 0.0 mol %≤a≤2.0 mol %, wherein D is at least one element other than Li, Ni, Mn, Co, and O;
Zr in a content b, wherein 0.01 mol %≤b≤5.0 mol %;
wherein x, y, z, a, and b are measured by ICP-OES;
wherein x+y+z+a+b is 100.0 mol %;
wherein the positive electrode active material has a Zr content Zr_{X}, wherein Zr_{X} is determined by XPS analysis, wherein Zr_{X} is expressed as a molar fraction compared to the sum of molar fractions of Co, Mn, Ni, and Zr as measured by XPS analysis,
wherein the positive electrode active material comprises carbon in a content C, wherein C is in wt. % as measured by carbon analyzer, and
wherein the ratio of Zr_{X} to C is between 10 and 30 (wt. %)⁻¹, preferably between 15 and 25 (wt. %)⁻¹, more preferably between 18 and 22 (wt. %)⁻¹.

A highly preferred embodiment is the positive electrode active material of the present invention, wherein D is at least one element other than Li, Ni, Mn, Co, Zr and O.

As appreciated by the skilled person all embodiments directed to the positive electrode active material according to the first aspect apply mutatis mutandis to the positive electrode active material according to the second aspect.

In a third aspect, the present invention concerns a positive electrode active material for solid-state batteries, wherein the positive electrode active material comprises Li, M′, and oxygen, wherein M′ comprises:
Ni in a content x between 75.0 mol %<x≤95.0 mol %, preferably 76.0 mol %≤x≤90.0 mol %, more preferably 77.0 mol %≤x≤88.0 mol %;
Mn in a content y, wherein 0.0 mol %≤y≤40.0 mol %;
Co in a content z, wherein 0.0 mol %≤z≤40.0 mol %;
D in a content a, wherein 0.0 mol %≤a≤2.0 mol %, wherein D is at least one element other than Li, Ni, Mn, Co, and O;
Zr in a content b, wherein 0.01 mol %≤b≤5.0 mol %;
wherein x, y, z, a, and b are measured by ICP-OES;
wherein x+y+z+a+b is 100.0 mol %;
wherein the positive electrode active material has a Zr content Zr_{X}, wherein Zr_{X} is determined by XPS analysis, wherein Zr_{X} is expressed as a molar fraction compared to the sum of molar fractions of Co, Mn, Ni, and Zr as measured by XPS analysis,
wherein the positive electrode active material comprises carbon in a content C, wherein C is in wt % as measured by carbon analyzer, and
wherein the ratio of Zr_{X} to C is between 7 and 30 (wt. %)⁻¹, preferably between 8 and 25 (wt. %)⁻¹, more preferably between 9 and 20 (wt. %)⁻¹.

A highly preferred embodiment is the positive electrode active material of the invention, wherein D is at least one element other than Li, Ni, Mn, Co, Zr and O.

As appreciated by the skilled person all embodiments directed to the positive electrode active material according to the first aspect apply mutatis mutandis to the positive electrode active material according to the third aspect.

### Process for Manufacturing

In a fourth aspect the present invention is also inclusive of a process for manufacturing a positive electrode active material, comprising the steps of:
preparing a slurry of a lithium transition metal-based oxide compound, Li, water, and an alcohol,
mixing said slurry with a source of Zr thereby obtaining a mixture, and
heating the mixture under an oxidizing atmosphere at a temperature between 250° C. and less than 500° C. for a time between 1 hour and 20 hours.

A highly preferred embodiment is the method for manufacturing the positive active material, wherein the positive active material is according to the first aspect of the invention, according to the second aspect of the invention and/or according to the third aspect of the invention.

In a preferred embodiment of the method the lithium transition metal-based oxide compound comprising Li, M′ and oxygen, wherein M′ comprises Ni, Mn, Co and D, wherein D is at least one element of the group consisting of: Al, B, Ba, Ca, Cr, Fe, Mg, Mo, Nb, S, Si, Sr, Ti, Y, V, W, and Zn; preferably Al, B, Cr, Nb, S, Si, Ti, Y, W.

Preferably the lithium transition metal oxide powder used is also typically prepared according to a lithiation process, that is the process wherein a mixture of a transition metal precursor and a lithium source is heated at a temperature preferably of at least 500° C. Typically, the transition metal precursor is prepared by coprecipitation of one or more transition metal sources, such as salts, and preferably sulfates of the M′ elements Ni, Mn and/or Co, in the presence of an alkali compound, such as an alkali hydroxide e.g. sodium hydroxide and/or ammonia.

Preferably, the method comprises a further step, before heating said mixture, of filtering and drying said mixture. Preferably, said drying is done under vacuum or under the constant flow of N₂ gas for at least 4 hours and at most 20 hours.

In a preferred embodiment of the method, the source of Zr is a Zr-alkoxide, preferably Zr-ethoxide, Zr-propoxide or Zr-butoxide, more preferably Zr-propoxide. In a preferred embodiment the Zr-alkoxide is mixed as a solid with the mixture. Alternatively, and more preferably, the Zr alkoxide is mixed as a solution with the slurry, wherein the solution comprises the Zr-alkoxide and a further alcohol, wherein the alkoxide group is a conjugate base of the further alcohol. For example, the Zr-alkoxide is Zr-propoxide, which is dissolved in propanol. Typically, the solution comprises 50-90 wt. % of the Zr-alkoxide by total weight of the solution. Examples of such a solution are a 70 wt. % Zr-propoxide in 1-propanol or a 80 wt. % Zr-butoxide in 1-butanol.

Preferably, the alcohol solvent is methanol, ethanol, propanol or butanol, preferably ethanol.

In a preferred embodiment the amount of water in the slurry is between 0.5 mol % to 25.0 mol %, with respect to metal content in the lithium transition metal oxide compound, preferably between 0.7 mol % to 10.0 mol %, more preferably between 1 mol % to 5 mol %, with respect to metal content in the lithium transition metal oxide compound. In a preferred embodiment the molar ratio of the water to the Zr-alkoxide in the slurry is at least 2:1, preferably at least 3:1, more preferably at least 4:1. In a preferred embodiment the molar ratio of the water to the Zr-alkoxide in the slurry is at most 10:1, preferably at most 8:1, more preferably at most 6:1. In a preferred embodiment the molar ratio of the water to the Zr-alkoxide in the slurry is between 2:1 and 10:1, preferably between 3:1 and 8:1 and more preferably between 4:1 and 6:1.

A preferred embodiment of the method is the heating the mixture at a temperature between 275° C. and 450° C., preferably between 30° and 400° C., more preferably between 325 and 375° C.

A preferred embodiment of the method is the heating the mixture, wherein the oxidizing atmosphere comprises oxygen, such as air, or consists of oxygen.

### Product-by-Process

In a fifth aspect the present invention concerns the positive electrode active material obtainable by the method according to the fourth aspect of the invention.

As appreciated by the skilled person all embodiments directed to the positive electrode active material according to the first aspect of the invention, the second aspect of the invention, the third aspect of the invention and/or the method according to the fourth aspect of the invention apply mutatis mutandis to the positive electrode active obtainable by the method according to the invention. For example, the various embodiments relating to the identity and amounts of Li, M′, Zr content Zr_{X}, carbon content C as explained herein in the context of the positive electrode active material are equally applicable to the positive electrode active material obtainable by the method for the preparation of the positive electrode active material.

### Battery

In a sixth aspect the present invention concerns a battery comprising the positive electrode active material according to the first aspect of the invention, according to the second aspect of the invention and/or according to the third aspect of the invention.

In a preferred embodiment the battery is a solid-state battery. Preferably the solid-state battery comprises a sulfide-based electrolyte. Preferably said electrolyte is a sulfide based solid electrolyte, more preferably the electrolyte comprises Li, P, and S. In a highly preferred embodiment the battery is a sulfide solid-state battery.

In a preferred embodiment the battery according to the invention has an efficiency of at least 88%, preferably at least 90%, more preferably at least 92%, most preferably at least 94%. As appreciated by the skilled person the efficiency of the battery is determined as explained under point D) of the Examples.

### Use

In a seventh aspect the present invention concerns a use of the positive electrode active material according to the first aspect of the invention, according to the second aspect of the invention and/or according to the third aspect of the invention in a battery.

A preferred embodiment is the use of the positive electrode active material in a battery, preferably a solid-state-battery, more preferably a sulfide solid-state-battery, to increase the efficiency of the battery.

In an eight aspect the present invention concerns a use of the battery according to invention in either one of a portable computer, a tablet, a mobile phone, an energy storage system, an electric vehicle or in a hybrid electric vehicle, preferably in an electric vehicle or in a hybrid electric vehicle.

### EXAMPLES

### A) ICP Analysis

The amount of Li, Ni, Mn, Co, and Zr in the positive electrode active material powder is measured with the Inductively Coupled Plasma (ICP-OES) method by using an Agilent ICP 720-ES. 2 grams of powder sample is dissolved into 10 mL of high purity hydrochloric acid (at least 37 wt % of HCl with respect to the total weight of solution) in an Erlenmeyer flask. The flask is covered by a glass and heated on a hot plate at 380° C. until complete dissolution of the powder. After being cooled to room temperature, the solution of the Erlenmeyer flask is poured into a 250 mL volumetric flask. Afterwards, the volumetric flask is filled with deionized water up to the 250 mL mark, followed by complete homogenization. An appropriate amount of solution is taken out by pipette and transferred into a 250 mL volumetric flask for the 2^{nd} dilution, where the volumetric flask is filled with internal standard and 10% hydrochloric acid up to the 250 mL mark and then homogenized. Finally, this 50 mL solution is used for ICP-OES measurement.

### B) Particle Size

The particle size distribution (PSD) of the positive electrode active material powder is measured by laser diffraction particle size analysis using a Malvern Mastersizer 3000 with a Hydro MV wet dispersion accessory after having dispersed each of the powder samples in an aqueous medium. In order to improve the dispersion of the powder, sufficient ultrasonic irradiation and stirring is applied, and an appropriate surfactant is introduced. D50 is defined as the particle size at 50% of the cumulative volume % distributions obtained from the Malvern Mastersizer 3000 with Hydro MV measurements.

### C) X-Ray Photoelectron Spectroscopy Analysis

In the present invention, X-ray photoelectron spectroscopy (XPS) is used to analyze the surface of positive electrode active material powder particles. In XPS measurement, the signal is acquired from the first few nanometers (e.g. 1 nm to 10 nm) of the uppermost part of a sample, i.e. surface layer. Therefore, all elements measured by XPS are contained in the surface layer.

For the surface analysis of the positive electrode active material powder particles, XPS measurement is carried out using a Thermo K-α+ spectrometer (Thermo Scientific). Monochromatic Al Kα radiation (hu=1486.6 eV) is used with a spot size of 400 μm and measurement angle of 45°. A wide survey scan to identify elements present at the surface is conducted at 200 eV pass energy. Cis peak having a maximum intensity (or centered) at a binding energy of 284.8 eV is used as a calibrate peak position after data collection. Accurate narrow scans are performed afterwards at 50 eV for at least 10 scans for each identified element to determine the precise surface composition.

Curve fitting is done with CasaXPS Version 2.3.19PR1.0 (Casa Software) using a Shirley-type background treatment and Scofield sensitivity factors. The fitting parameters are according to Table 1a. Line shape GL(30) is the Gaussian/Lorentzian product formula with 70% Gaussian line and 30% Lorentzian line.

TABLE 1a
XPS fitting parameter for Ni2p3, Mn2p3, Co2p3, and Zr3d.

| | Sensitivity | Fitting | Defined | Line |
|---|---|---|---|---|
| Element | factor | range (eV) | peak(s) | shape |
| Ni | 14.61 | 851.3 ± 0.1- | Ni2p3, Ni2p3 | GL(30) |
| | | 868.4 ± 0.1 | satellite | |
| Mn | 9.17 | 638.4 ± 0.1- | Mn2p3, Mn2p3 | GL(30) |
| | | 650.2 ± 0.1 | satellite | |
| Co | 12.62 | 776.7 ± 0.4- | Co2p3, Co2p3 | GL(30) |
| | | 793.2 ± 0.4 | satellite | |
| Zr | 7.04 | 178.3 ± 0.1- | Zr3d3, | GL(30) |
| | | 188.6 ± 0.1 | Zr3d1 | |

For Zr and Co peaks, constraints are set for each defined peak according to Table 1b.

TABLE 1b
XPS fitting constraints for peaks fitting.

| | | Fitting range | FWHM | |
|---|---|---|---|---|
| | Defined | constraint | constraint | Area |
| Element | peak | (eV) | (eV) | constraint |
| Zr | Zr3d1 | 183.0-186.0 | Equal to Zr3d3 | 66.7% of Zr3d3 |
| | Zr3d3 | 180.0-183.0 | 0.5-4.0 | No constraint set |
| Co | Co2p3 | 776.0-783.0 | 0.5-5.0 | No constraint set |
| | Co2p3 | 785.1-792.0 | 0.5-6.0 | No constraint set |
| | satellite | | | |

The Zr surface contents as determined by XPS are expressed as a molar fraction of Zr in the surface layer of the particles divided by the total content of Ni, Mn, Co, and Zr in said surface layer. It is calculated as follows:

$$fraction of Zr = {Zr}_{B} = \frac{Zr ( at \% )}{Ni ( at \% ) + Mn ( at \% ) + Co ( at \% ) + Zr ( at \% )} .$$

### D) Sulfide Solid-State Battery Testing

### D1) Sulfide Solid-State Battery Preparation

### Positive Electrode Preparation:

For the preparation of a positive electrode, a slurry contains positive electrode active material powder, Li—P—S based solid electrolyte, carbon (Super-P, Timcal), and binder (RC-10, Arkema)—with a formulation of 64.0:30.0:3.0:3.0 by weight—in butyl acetate solvent is mixed in Ar-filled glove box. The slurry is casted on one side of an aluminum foil followed by drying the slurry coated foil in a vacuum oven to obtain a positive electrode. The obtained positive electrode is punched with a diameter of 10 nm wherein the active material loading amount is around 4 mg/cm².

### Negative Electrode Preparation:

For the preparation of negative electrode, Li foil (diameter 3 mm, thickness 100 μm) is placed centered on the top of In foil (diameter 10 nm, thickness 100 μm) and pressed to form Li—In alloy negative electrode.

### Separator

For the preparation of separator which also has a function of the solid electrolyte in a battery, the Li—P—S based solid electrolyte is pelletized with a pressure of 250 MPa to obtain 100 μm pellet thickness.

### Cell Assembly

A sulfide solid-state battery is assembled in an argon-filled glovebox with such order from bottom to top: positive electrode comprising Al current collector with the coated part on the top—separator—negative electrode with Li side on the top—Cu current collector. The stacked components are pressed together with a pressure of 250 MPa and placed in an external cage to prevent air exposure.

### D2) Testing Method

The testing method is a conventional “constant cut-off voltage” test. The conventional cell test in the present invention follows the schedule shown in Table 2. Each cell is cycled at 60° C. using a Toscat-3100 computer-controlled galvanostatic cycling station (from Toyo).

The schedule uses a 1 C current definition of 160 mA/g. The initial charge capacity (CQ1) and discharge capacity (DQ1) are measured in constant current mode (CC) at C rate of 0.1 C in voltage range: 4.3 V to 2.5 V (Li/Li⁺) or 3.7 V to 1.9 V (InLi/Li⁺).

The efficiency EF is expressed in % as follows:

$$EF ( \% ) = \frac{DQ 1}{CQ 1} \times 100$$

TABLE 2
Cycling schedule for sulfide solid-state battery testing method

| Charge | | | | Discharge | | | |
|---|---|---|---|---|---|---|---|
| C | End | Rest | V/Li metal | C | End | Rest | V/Li metal |
| Rate | current | (min) | (V) | Rate | current | (min) | (V) |
| 0.1 | — | 30 | 4.3 | 0.1 | — | 30 | 2.5 |

### E) Carbon Analyzer

The content of carbon of the positive electrode active material powder is measured by Horiba Emia-Expert carbon/sulfur analyzer. 1 gram of the positive electrode active material powder is placed in a ceramic crucible in a high frequency induction furnace. 1.5 gram of tungsten and 0.3 gram of tin as accelerators are added into the crucible as accelerators. The powder is heated at a programmable temperature wherein gases produced during the combustion are then analyzed by Infrared detectors. The analysis of CO₂ and CO determines carbon concentration.

### F) Surface Area Analysis

The specific surface area of the positive electrode active material is measured with the Brunauer-Emmett-Teller (BET) method by using a Micromeritics Tristar II 3020. A powder sample is heated at 300° C. under a nitrogen (N₂) gas for 1 hour prior to the measurement in order to remove adsorbed species. The dried powder is put into the sample tube. The sample is then de-gassed at 30° C. for 10 minutes. The instrument performs the nitrogen adsorption test at 77 K. By obtaining the nitrogen isothermal absorption/desorption curve, the total specific surface area of the sample in m²/g is derived.

The invention is further illustrated by the following (non-limitative) examples:

### Comparative Example 1

A single-crystalline positive electrode active material labelled as CEX1 was prepared according to the following steps:

Step 1) Transition metal oxidized hydroxide precursor preparation: a nickel-based transition metal oxidized hydroxide powder (TMH1) having a metal composition Ni_{0.8}Mn_{0.1}Co_{0.1} was prepared by a co-precipitation process in a large-scale continuous stirred tank reactor (CSTR) with mixed nickel manganese cobalt sulfates, sodium hydroxide, and ammonia.

Step 2) Precursor oxidation: the TMH1 prepared from Step 1) was heated at 400° C. for 7 hours under an oxidizing atmosphere to obtain a heated product.

Step 3) First mixing: the transition metal-based oxidized hydroxide precursor and LiOH as a lithium source were homogenously mix with a lithium to metal M′ (Li/M′) ratio of 1.02 in an industrial blending equipment to obtain a first mixture.

Step 4) First heating: the first mixture from Step 3) was heated at 730° C. for 10 hours under an oxygen atmosphere. The heated product was crushed, classified, and sieved to obtain a first heated product.

Step 5) Second heating: the first heated product from Step 4) was heated at 920° C. for 10 hours under an oxygen atmosphere to obtain a second heated product.

Step 6) Wet bead milling: the second heated product from Step 5) was bead milled in a solution containing 0.5 mol % of Co with respect to the total molar contents of Ni, Mn, and Co in the second heated product followed by drying and sieving process to obtain a milled product.

The bead milling solid to solution weight ratio was 1:1 and was conducted for 20 minutes.

Step 7) Second mixing: the milled product obtained from Step 6) was mixed in an industrial blender with 1.5 mol % of Co from Co₃O₄ and 4 mol % of Li from LiOH, each with respect to the total molar contents of Ni, Mn, and Co in the milled product to obtain a second mixture.

Step 8) Third heating: the second mixture from Step 7) was heated at 760° C. for 10 hours under an oxidizing atmosphere followed by crushing and sieving with 250 ppm of alumina powder to obtain an intermediate product.

Step 9) Wet mixing: step 9a) to Step 9c) below was applied to introduce Zr into the positive electrode active material:

Step 9a) Zr solution preparation: 0.8 mol % of Zr from Zr-propoxide (70 wt. % Zr-propoxide in n-propanol solution), 1.6 mol % of Li from Li-ethoxide powder, each with respect to the total molar contents of Ni, Mn, and Co in the intermediate product, and ethanol solvent were mixed to form a solution. The amount of ethanol solvent was 55 wt. % of the total weight of the designated intermediate product to mix in the Step 9b).

Step 9b) Mixing: the intermediate product obtained from Step 8) was mixed with Zr solution prepared in Step 9a) for 20 minutes in a heatable reactor.

Step 9c) Heating: 70° C. heat was applied to reactor in Step 9b) while at the same time reactor was connected to a vacuum pump to evaporate volatile phases. A dried powder was obtained from this step.

Step 10) Fourth heating: the dried powder from Step 9c) was heated at 350° C. for 6 hours under an oxygen atmosphere to obtain CEX1 having M′ comprising Ni, Mn, Co and Zr in a ratio Ni:Mn:Co:Zr of 0.79:0.10:0.11:0.007 as obtained by ICP-OES. CEX1 has a D50 of 4 μm.

### Example 1

A single-crystalline positive electrode active material labelled as EX1 was prepared according to the following steps:

Step 1) Zr solution preparation: 0.8 mol % of Zr from Zr-propoxide (70 wt. % Zr-propoxide in n-propanol solution) was dissolved in 3 grams of ethanol.

Step 2) Slurry preparation: 70 grams of the intermediate product obtained from Step 8) in CEX1 preparation was mixed with 1.6 mol % of LiOH and 4 mol % of water, both relative to M′, and 26 grams of ethanol to form a slurry.

Step 3) Mixing: Zr solution prepared from Step 1) and slurry prepared from Step 2) were mixed and stirred for 15 hours at room temperature followed by filtering and drying at 80° C. in vacuum for 6 hours.

Step 4) Heating: the dried powder from Step 3) was heated at 350° C. for 6 hours under an oxygen atmosphere to obtain EX1 having M′ comprising Ni, Mn, Co and Zr in a ratio Ni:Mn:Co:Zr of 0.79:0.10:0.11:0.007 as obtained by ICP-OES. EX1 has a D50 of 4 μm.

### Comparative Example 2

A single-crystalline positive electrode active material labelled as CEX2 was prepared according to the following steps:

Step 1) Transition metal oxidized hydroxide precursor preparation: a nickel-based transition metal oxidized hydroxide powder (TMH2) having a metal composition Ni_{0.85}Mn_{0.07}Co_{0.08} was prepared by a co-precipitation process in a large-scale continuous stirred tank reactor (CSTR) with mixed nickel manganese cobalt sulfates, sodium hydroxide, and ammonia.

Step 2) Precursor oxidation: the TMH2 prepared from Step 1) was heated at 400° C. for 7 hours under an oxidizing atmosphere to obtain a heated product.

Step 3) First mixing: the heated product prepared from Step 2) was mixed with LiOH in an industrial blender to obtain a first mixture having a lithium to metal M′ (Li/M′) ratio of 0.96.

Step 4) First heating: the first mixture from Step 3) was heated at 890° C. for 11 hours under an oxidizing atmosphere to obtain a first heated product.

Step 5) Wet bead milling: the first heated product from Step 4) was bead milled in a solution containing 0.5 mol % of Co with respect to the total molar contents of Ni, Mn, and Co in the first heated product followed by drying and sieving process to obtain a milled product. The bead milling solid to solution weight ratio was 6:4 and was conducted for 20 minutes.

Step 6) Second mixing: the milled product obtained from Step 5) was mixed in an industrial blender with 1.5 mol % of Co from Co₃O₄ and 7.5 mol % of Li from LiOH, each with respect to the total molar contents of Ni, Mn, and Co in the milled product to obtain a second mixture.

Step 7) Second heating: the second mixture from Step 6) was heated at 760° C. for 10 hours under an oxidizing atmosphere followed by crushing and sieving with 250 ppm of alumina powder to obtain an intermediate product.

Step 8) Wet mixing: Step 8a) to Step 8c) below was applied to introduce Zr into the positive electrode active material:

Step 8a) Zr solution preparation: 0.75 mol % of Zr from Zr-propoxide (70 wt. % Zr-propoxide in n-propanol solution), 1.5 mol % of Li from Li-ethoxide powder, each with respect to the total molar contents of Ni, Mn, and Co in the intermediate product, and ethanol solvent were mixed to form a solution. The amount of ethanol solvent was 55 wt. % of the total weight of the designated intermediate product to mix in the Step 8b).

Step 8b) Mixing: the intermediate product obtained from Step 7) was mixed with Zr solution prepared in Step 7a) for 20 minutes in a heatable reactor.

Step 8c) Heating: 70° C. heat was applied to reactor in Step 8b) while at the same time reactor was connected to a vacuum pump to evaporate volatile phases. A dried powder was obtained from this step.

Step 9) Third heating: the dried powder from Step 8c) was heated at 350° C. for 6 hours under an oxygen atmosphere to obtain CEX2 having M′ comprising Ni, Mn, Co and Zr in a ratio Ni:Mn:Co:Zr of 0.84:0.07:0.09:0.007 as obtained by ICP-OES. CEX2 has a D50 of 4 μm.

### Example 2

A single-crystalline positive electrode active material labelled as EX2.1 was prepared according to the following steps:

Step 1) Zr solution preparation: 0.75 mol % of Zr from Zr-propoxide (70 wt. % Zr-propoxide in n-propanol solution) was dissolved in 3 grams of ethanol.

Step 2) Slurry preparation: 70 grams of the intermediate product obtained from Step 7) in CEX2 preparation was mixed with 1.5 mol % of LiOH and 3.75 mol % of water, both relative to M′, and 26 grams ethanol to form a slurry.

Step 3) Mixing: Zr solution prepared from Step 1) and slurry prepared from Step 2) were mixed and stirred for 15 hours at room temperature followed by filtering and drying at 80° C. in vacuum for 6 hours.

Step 4) Heating: the dried powder from Step 3) was heated at 350° C. for 6 hours under an oxygen atmosphere to obtain EX2.1 having M′ comprising Ni, Mn, Co and Zr in a ratio Ni:Mn:Co:Zr of 0.84:0.07:0.09:0.007 as obtained by ICP-OES. EX2.1 has a D50 of 4 μm.

EX2.2 was prepared according to the same method as EX2.1, except that the 0.6 mol % of Zr from Zr-propoxide was used in Step 1) and 1.2 mol % of Li from LiOH and 3 mol % of H₂O were used in Step 2). EX2.2 having M′ comprising Ni, Mn, Co and Zr in a ratio Ni:Mn:Co:Zr of 0.84:0.07:0.09:0.006 as obtained by ICP-OES. EX2.2 has a D50 of 4 μm.

EX2.3 was prepared according to the same method as EX2.1, except that the 0.45 mol % of Zr from Zr-propoxide was used in Step 1) 0.9 mol % of Li from LiOH and 2.25 mol % of H₂O were used in Step 2). EX2.3 having M′ comprising Ni, Mn, Co and Zr in a ratio Ni:Mn:Co:Zr of 0.84:0.07:0.09:0.004 as obtained by ICP-OES. EX2.3 has a D50 of 4 μm.

### Comparative Example 3

A single-crystalline positive electrode active material labelled as CEX3 was prepared according to the following steps:

Step 1) Transition metal oxidized hydroxide precursor preparation: a nickel-based transition metal oxidized hydroxide powder (TMH3) having a metal composition of Ni_{0.63}Mn_{0.22}Co_{0.15} was prepared by a co-precipitation process in a large-scale continuous stirred tank reactor (CSTR) with mixed nickel manganese cobalt sulphates, sodium hydroxide, and ammonia.

Step 2) First mixing: the TMH3 prepared from Step 1) was mixed with Li₂CO₃ in an industrial blender to obtain a first mixture having a lithium to metal M′ (Li/M′) ratio of 0.85.

Step 3) First heating: the first mixture from Step 2) was heated at 900° C. for 10 hours under dry air atmosphere to obtain a first heated cake.

Step 4) Second mixing: the first heated cake from Step 3) was mixed with LiOH in an industrial blender to obtain a second mixture having a lithium to metal M′ (Li/M′) ratio of 1.05.

Step 5) Second heating: the second mixture from Step 4) was heated at 950° C. for 10.2 hours under dry air, followed by wet milling, drying, and sieving process to obtain a second heated product.

Step 6) Third mixing: the second heated product from Step 5) was mixed with 2 mol % of Co₃O₄ and 5 mol % of LiOH, each with respect to the total molar contents of Ni, Mn, and Co to obtain a third mixture.

Step 7) Third heating: the third mixture from Step 6) was heated at 775° C. for 12 hours under dry air to produce an intermediate product.

Step 8) Wet mixing: Step 8a) to Step 8c) below was applied to introduce Zr into the positive electrode active material:

Step 8a) Zr solution preparation: 0.46 mol % of Zr from Zr-propoxide (70 wt. % Zr-propoxide in n-propanol solution), 0.92 mol % of Li from Li-ethoxide powder, each with respect to the total molar contents of Ni, Mn, and Co in the intermediate product, and ethanol solvent were mixed to form a solution. The amount of ethanol solvent was 55 wt. % of the total weight of the designated intermediate product to mix in the Step 8b).

Step 8b) Mixing: the intermediate product obtained from Step 7) was mixed with Zr solution prepared in Step 8a) for 20 minutes in a heatable reactor.

Step 8c) Heating: 70° C. heat was applied to reactor in Step 8b) while at the same time reactor was connected to a vacuum pump to evaporate volatile phases. A dried powder was obtained from this step.

Step 9) Fourth heating: the dried powder from Step 8c) was heated at 350° C. for 6 hours under an oxygen atmosphere to obtain CEX3 having M′ comprising Ni, Mn, Co and Zr in a ratio Ni:Mn:Co:Zr of 0.62:0.22:0.16:0.004 as obtained by ICP-OES. CEX3 has a D50 of 6 μm.

### Example 3

A single-crystalline positive electrode active material labelled as EX3 was prepared according to the following steps:

Step 1) Zr solution preparation: 0.46 mol % of Zr from Zr-propoxide (70 wt. % Zr-propoxide in n-propanol solution) was dissolved in 3 grams of ethanol.

Step 2) Slurry preparation: 70 grams of the intermediate product obtained from Step 7) in CEX3 preparation was mixed with 0.92 mol % of LiOH and 2.3 mol % of water, both relative to M′, and 26 grams ethanol to form a slurry.

Step 3) Mixing: Zr solution prepared from Step 1) and a slurry prepared from Step 2) were mixed and stirred for 15 hours at room temperature followed by filtering and drying at 80° C. in vacuum for 6 hours.

Step 4) Heating: the dried powder from Step 3) was heated at 350° C. for 6 hours under an oxygen atmosphere to obtain EX3 having M′ comprising Ni, Mn, Co and Zr in a ratio Ni:Mn:Co:Zr of 0.62:0.22:0.16:0.004 as obtained by ICP-OES. EX2.1 has a D50 of 6 μm.

### Comparative Example 4

A polycrystalline positive electrode active material labelled as CEX4 was prepared according to the following steps:

Step 1) Transition metal oxidized hydroxide precursor preparation: a nickel-based transition metal oxidized hydroxide powder (TMH4) having a metal composition Ni_{0.83}Mn_{0.12}Co_{0.05} was prepared by a co-precipitation process in a large-scale continuous stirred tank reactor (CSTR) with mixed nickel manganese cobalt sulfates, sodium hydroxide, and ammonia.

Step 2) First mixing: the TMH4 prepared from Step 1) was mixed with LiOH in an industrial blender to obtain a first mixture having a lithium to metal ratio of 0.96.

Step 3) First heating: the first mixture from Step 2) was heated at 765° C. for 10 hours under an oxidizing atmosphere to obtain a first heated product followed by milling and sieving.

Step 4) Second mixing: the first heated product from Step 3) and LiOH as a lithium source were homogenously mixed with a lithium to metal M′ (Li/M′) ratio of 1.02 in an industrial blending equipment to obtain a second mixture.

Step 5) Second heating: the second mixture from Step 4) was heated at 780° C. for 12 hours under an oxygen atmosphere to obtain an intermediate product.

Step 6) Wet mixing: step 6a) to Step 6c) below was applied to introduce Zr into the positive electrode active material:

Step 6a) Zr solution preparation: 0.63 mol % of Zr from Zr-propoxide (70 wt. % Zr-propoxide in n-propanol solution), 1.26 mol % of Li from Li-ethoxide powder, each with respect to the total molar contents of Ni, Mn, and Co in the intermediate product, and ethanol solvent were mixed to form a solution. The amount of ethanol solvent was 55 wt. % of the total weight of the designated intermediate product to mix in the Step 6b).

Step 6b) Mixing: the intermediate product obtained from Step 5) was mixed with Zr solution prepared in Step 6a) for 20 minutes in a heatable reactor.

Step 6c) Heating: 70° C. heat was applied to reactor in Step 6b) while at the same time reactor was connected to a vacuum pump to evaporate volatile phases. A dried powder was obtained from this step.

Step 7) Third heating: the dried powder from Step 6c) was heated at 350° C. for 6 hours under an oxygen atmosphere to obtain CEX4 having M′ comprising Ni, Mn, Co and Zr in a ratio Ni:Mn:Co:Zr of 0.82:0.12:0.05:0.006 as obtained by ICP-OES. CEX4 has a D50 of 6 μm.

### Example 4

A polycrystalline positive electrode active material labelled as EX4 was prepared according to the following steps:

Step 1) Zr solution preparation: 0.63 mol % of Zr from Zr-propoxide (70 wt. % Zr-propoxide in n-propanol solution) was dissolved in 3 grams of ethanol.

Step 2) Slurry preparation: 70 grams of the intermediate product obtained from Step 5) in CEX4 preparation was mixed with 1.26 mol % of LiOH and 3.15 mol % of water, both relative to M′, and 26 grams ethanol to form a slurry.

Step 3) Mixing: Zr solution prepared from Step 1) and slurry prepared from Step 2) were mixed and stirred for 15 hours at room temperature followed by filtering and drying at 80° C. in vacuum for 6 hours.

Step 4) Heating: The dried powder from Step 3) was heated at 350° C. for 6 hours under an oxygen atmosphere to obtain EX3 having M′ comprising Ni, Mn, Co and Zr in a ratio Ni:Mn:Co:Zr of 0.83:0.120:0.050:0.006 as obtained by ICP-OES. EX4 has a D50 of 6 μm.

### Comparative Example 5

A polycrystalline positive electrode active material labelled as CEX5, was prepared according to the following steps:

Step 1) Transition metal oxidized hydroxide precursor preparation: a nickel-based transition metal oxidized hydroxide powder (TMH5) having a metal composition Ni_{0.625}Mn_{0.175}Co_{0.200} was prepared by a co-precipitation process in a large-scale continuous stirred tank reactor (CSTR) with mixed nickel manganese cobalt sulfates, sodium hydroxide, and ammonia.

Step 2) First mixing: the transition metal-based oxidized hydroxide precursor and LiOH as a lithium source were homogenously mixed with a lithium to metal M′ (Li/M′) ratio of 1.03 in an industrial blending equipment to obtain a first mixture.

Step 3) First heating: the first mixture from Step 2) was heated at 830° C. for 10 hours under an oxygen atmosphere. The heated product was crushed, classified, and sieved to obtain an intermediate product.

Step 4) Wet mixing: step 4a) to Step 4c) below was applied to introduce Zr into the positive electrode active material:

Step 4a) Zr solution preparation: 0.25 mol % of Zr from Zr-propoxide (70 wt. % Zr-propoxide in n-propanol solution), 0.5 mol % of Li from Li-ethoxide powder, each with respect to the total molar contents of Ni, Mn, and Co in the intermediate product, and ethanol solvent were mixed to form a solution. The amount of ethanol solvent was 55 wt. % of the total weight of the designated intermediate product to mix in the Step 4b).

Step 4b) Mixing: the intermediate product obtained from Step 3) was mixed with Zr solution prepared in Step 4a) for 20 minutes in a heatable reactor.

Step 4c) Heating: 70° C. heat was applied to reactor in Step 4b) while at the same time reactor was connected to a vacuum pump to evaporate volatile phases. A dried powder was obtained from this step.

5) Second heating: The dried powder from Step 4c) was heated at 350° C. for 6 hours under an oxygen atmosphere to obtain CEX5 having M′ comprising Ni, Mn, Co and Zr in a ratio Ni:Mn:Co:Zr of 0.62:0.17:0.20:0.002 as obtained by ICP-OES. CEX3.2 has a D50 of 10 μm.

### Example 5

A polycrystalline positive electrode active material labelled as EX5 was prepared according to the following steps:

Step 1) Zr solution preparation: 0.25 mol % of Zr from Zr-propoxide (70 wt % Zr-propoxide in n-propanol solution) was dissolved in 3 grams of ethanol.

Step 2) Slurry preparation: 70 grams of the intermediate product obtained from Step 3) in CEX5 preparation was mixed with 0.5 mol % of LiOH and 1.25 mol % of water, both relative to M′, and 26 grams ethanol to form a slurry.

Step 3) Mixing: Zr solution prepared from Step 1) and slurry prepared from Step 2) were mixed and stirred for 15 hours at room temperature followed by filtering and drying at 80° C. in vacuum for 6 hours.

Step 4) Heating: The dried powder from Step 3) was heated at 350° C. for 6 hours under an oxygen atmosphere to obtain EX3 having M′ comprising Ni, Mn, Co and Zr in a ratio Ni:Mn:Co:Zr of 0.62:0.17:0.20:0.002 as obtained by ICP-OES. EX5 has a D50 of 10 μm.

TABLE 3
Summary of the composition, surface area, and the corresponding
electrochemical properties of example and comparative examples.

| | | | | Surface | | | | |
|---|---|---|---|---|---|---|---|---|
| | Composition | | | area | | | | Electrochemical |
| | Ni | Zr | Carbon | (SA) | Carbon/ | XPS | | properties |
| ID | (mol %) | (mol %) | (wt %) | (m²/g) | SA | Zr_{X}* | Zrₓ/C | EF (%) |
| CEX1 | 78.4 | 0.72 | 0.13 | 0.77 | 0.17 | 0.86 | 6.4 | 87.2 |
| EX1 | 78.4 | 0.72 | 0.08 | 0.81 | 0.10 | 0.97 | 11.4 | 89.4 |
| CEX2 | 83.6 | 0.67 | 0.11 | 0.70 | 0.16 | 0.77 | 6.7 | 89.4 |
| EX2.1 | 83.5 | 0.66 | 0.07 | 0.82 | 0.09 | 0.93 | 13.1 | 89.7 |
| EX2.2 | 83.7 | 0.56 | 0.06 | 0.81 | 0.08 | 0.86 | 13.5 | 90.7 |
| EX2.3 | 83.8 | 0.40 | 0.06 | 0.72 | 0.08 | 0.89 | 14.7 | 92.3 |
| CEX3 | 61.7 | 0.41 | 0.11 | 0.74 | 0.14 | 0.80 | 7.5 | 85.4 |
| EX3 | 61.7 | 0.41 | 0.05 | 0.52 | 0.10 | 0.95 | 19.3 | 88.7 |
| CEX4 | 82.5 | 0.57 | 0.20 | 0.64 | 0.32 | 0.95 | 4.6 | 87.1 |
| EX4 | 82.5 | 0.57 | 0.11 | 0.65 | 0.17 | 0.95 | 8.5 | 94.0 |
| CEX5 | 62.4 | 0.23 | 0.07 | 0.21 | 0.33 | 0.69 | 9.6 | 90.3 |
| EX5 | 62.4 | 0.23 | 0.04 | 0.19 | 0.17 | 0.87 | 20.3 | 94.5 |

*Relative to molar contents of Ni, Mn, Co, and Zr

Table 3 summarizes composition, surface area, and the corresponding electrochemical properties of examples and comparative examples. The XPS analysis result Zr_{X} shows atomic ratio (equivalent with molar ratio) of Zr with respect to the total atomic fraction of Ni, Mn, Co, and Zr. The Zr_{X} higher than 0 indicates that Zr is presence in the surface of the positive electrode active material as associated with the XPS measurement which signal is acquired from the first few nanometers (e.g. 1 nm to 10 nm) of the uppermost part of a sample, i.e. surface layer.

CEX1 and EX1 are single-crystalline positive electrode active material having Ni content around 78.4 mol % and Zr content around 0.72 mol %. The difference in the process of Zr introduction leads EX1 to have lower carbon content and higher Zr_{X} in comparison with CEX1. It is further observed that the higher Zr_{X} to C ratio is linked with the improvement in the efficiency of a solid-state battery.

CEX2 and EX2.1 are single-crystalline positive electrode active material having Ni content around 83.6 mol % and Zr content around 0.67 mol %. EX2.1 prepared according to the method in this invention, shows higher Zr_{X} to C ratio, and therefore is connected to higher electrochemical cell efficiency, in comparison with CEX2. EX2.2 and EX2.3 comprises Zr in amount of 0.56 mol % and 0.40 mol %, respectively. Both examples display a similar ratio of Zrₓ to C as for EX2.1 and achieve an improved battery efficiency.

The invention further illustrated by the comparison between CEX3 and EX3, CEX4 and EX4, as well as CEX5 and EX5. CEX3 and EX3 are single-crystalline positive electrode active material having Ni content around 61.7 mol % and Zr content around 0.41 mol %. CEX4 and EX4 are polycrystalline positive electrode active material having Ni content around 82.5 mol % and Zr content around 0.57 mol %. Lastly, CEX5 and EX5 are polycrystalline positive electrode active material having Ni content around 62.4 mol % and Zr content around 0.25 mol %. All these examples show enhanced efficiency linked to the higher Zr_{X} to C ratio of each comparative example. The invention works for both single-crystalline and polycrystalline material and Ni range from 55.0 mol % to 95.0 mol %.

1-18. (canceled)

19. A positive electrode active material for solid-state batteries, wherein the positive electrode active material comprises Li, M′, and oxygen, wherein M′ comprises:
Ni in a content x, wherein 55.0 mol %≤x≤95.0 mol %,
Mn in a content y, wherein 0.0 mol %≤y≤40.0 mol %,
Co in a content z, wherein 0.0 mol %≤z≤40.0 mol %,
D in a content a, wherein 0.0 mol %≤a≤2.0 mol %, wherein D is at least one element other than Li, Ni, Mn, Co, and O,
Zr in a content b, wherein 0.01 mol %≤b≤5.0 mol %,
wherein x, y, z, a, and b are measured by ICP-OES,
wherein x+y+z+a+b is 100.0 mol %,
wherein the positive electrode active material has a Zr content Zr_{X}, wherein Zr_{X} is determined by XPS analysis, wherein Zr_{X} is expressed as a molar fraction compared to the sum of molar fractions of Co, Mn, Ni, and Zr as measured by XPS analysis,
wherein the positive electrode active material comprises carbon in a content C, wherein C is in wt. % by total weight of the positive electrode active material, as measured by carbon analyzer,
wherein the ratio of Zr_{X} to C is between 52−0.413·x and 42−0.413·x (wt. %)⁻¹.

20. The positive electrode active material according to claim 19, wherein D is at least one element other than Li, Ni, Mn, Co, Zr and O.

21. The positive electrode active material according to claim 19, wherein D comprises at least one element selected from the group consisting of: Al, B, Ba, Ca, Cr, Fe, Mg, Mo, Nb, S, Si, Sr, Ti, Y, V, W, and Zn.

22. The positive electrode active material according to claim 19, wherein the ratio Zr_{X} to C is between 50−0.413·x and 43−0.413·x (wt. %)⁻¹.

23. The positive electrode active material according to claim 19, wherein C≤0.15 wt. % by total weight of the positive electrode active material.

24. The positive electrode active material according to claim 19, having a surface area SA, as determined by BET measurement, wherein the ratio of C to SA is at most 0.25 wt. % (g/m²).

25. The positive electrode active material according to claim 19, wherein 60.0 mol %≤x≤90.0 mol %.

26. The positive electrode active material according to claim 19, wherein 0.05 mol %≤b≤2.5 mol %.

27. The positive electrode active material according to claim 19, wherein the positive electrode active material is a poly-crystalline powder.

28. The positive electrode active material according to claim 26, wherein the secondary particle median size D50 is at least 2.0 μm and at most 15.0 μm, as determined by laser diffraction particle size analysis.

29. A method for manufacturing a positive electrode active material, wherein said method comprises:
preparing a slurry of lithium transition metal-based oxide compound, Li, water, and an alcohol,
mixing said slurry with a source of Zr, and
heating the mixture under an oxidizing atmosphere in a furnace at a temperature between 250° C. and less than 500° C. for a time between 1 hour and 20 hours to obtain the positive electrode active material.

30. The method according to claim 29, wherein the method further comprises a step, before heating said mixture, of filtering and drying said mixture.

31. The method according to claim 29, wherein the source of Zr is Zr-propoxide.

32. The method according to claim 29, wherein the amount of water in the slurry is between 0.5 mol % to 25.0 mol %, with respect to metal content in the lithium transition metal oxide compound.

33. The method according to claim 29, wherein the positive electrode active material comprises Li, M′, and oxygen, wherein M′ comprises:
Ni in a content x, wherein 55.0 mol %≤x≤95.0 mol %,
Mn in a content y, wherein 0.0 mol %≤y≤40.0 mol %,
Co in a content z, wherein 0.0 mol %≤z≤40.0 mol %,
D in a content a, wherein 0.0 mol %≤a≤2.0 mol %, wherein D is at least one element other than Li, Ni, Mn, Co, and O,
Zr in a content b, wherein 0.01 mol %≤b≤5.0 mol %,
wherein x, y, z, a, and b are measured by ICP-OES,
wherein x+y+z+a+b is 100.0 mol %,
wherein the positive electrode active material has a Zr content Zr_{X}, wherein Zr_{X} is determined by XPS analysis, wherein Zr_{X} is expressed as a molar fraction compared to the sum of molar fractions of Co, Mn, Ni, and Zr as measured by XPS analysis,
wherein the positive electrode active material comprises carbon in a content C, wherein C is in wt. % by total weight of the positive electrode active material, as measured by carbon analyzer, wherein the ratio of Zr_{X} to C is between 52−0.413·x and 42−0.413·x (wt. %)⁻¹.

34. A solid-state battery comprising the positive electrode active material according to claim 19.

35. The solid-state battery according to claim 34, wherein said solid-state battery comprises a sulfide based solid electrolyte comprising Li, P, and S.

36. A portable computer, a tablet, a mobile phone, an energy storage system, an electric vehicle or a hybrid electric vehicle comprising the solid-state battery according to claim 34.
